(19) United States
(12) Patent Application Publication
(10) Pub. No.: US 2026/0217922 A1
(43) Pub. Date: Jul. 30, 2026

(54) INTERACTIVE GRAPHENE POLYMER

(71) Applicant: MITO MATERIAL SOLUTIONS, INC., Indianapolis, IN (US)

(72) Inventors: Kevin KEITH, Indianapolis, IN (US); Mahdi GHAZIZADEH, Indianapolis, IN (US)

(21) Appl. No.: 19/158,269

(22) PCT Filed: Feb. 20, 2024
(86) PCT No.: PCT/US2024/016428

§ 371 Date: Aug. 20, 2025

Related U.S. Application Data
(60) Provisional application No. 63/447,166, filed on Feb. 21, 2023.
(60) Provisional application No. 63/584,119, filed on Sep. 20, 2023.

(51) Int. Cl. C08J 3/20; C08J 5/00; C08J 5/04; C08J 5/18; C08K 3/04

(52) U.S. Cl. CPC C08J 3/20; C08J 5/005; C08J 5/042; C08J 5/18; C08K 3/042; C08K 2201/005; C08K 2201/006; C08K 2201/011

(57) ABSTRACT

Disclosed herein are graphene compositions and methods of use and making thereof. The graphene compositions may comprise graphene and a polymer. The graphene compositions may be used in fiber sizing.

### RELATED APPLICATIONS

This application claims the benefit of U.S. Provisional Application No. 63/584,119, filed Sep. 20, 2023, and U.S. Provisional Application No. 63/447,166, filed Feb. 21, 2023, the entire disclosures of each of which are incorporated herein by reference.

### BACKGROUND

Graphene has shown promise in the use of polymer materials and membranes in lab and small-scale settings to achieve drastic increases in mechanical, thermal, electrical, and vibration properties at extremely low doses. To facilitate larger scale adoption, an increase in ease of handling is needed as to not expose personnel to nanomaterials that are possibly toxic. However, to date, no graphene dosing pellets exist on the market. Thus, there remains an ongoing, unmet need for new compositions that facilitate the handling of graphene.

### SUMMARY OF THE INVENTION

Water-soluble polymers, such as polyvinylpyrrolidone (PVP), may act as both a binder and surfactant to help promote dry powder suspensions and dispersibility. With the aid of PVP's binding properties, pellets having high concentrations of graphene may be formed by combining graphene and PVP within certain ratios and under certain drying conditions.

Disclosed herein are compositions comprising graphene and polymer (e.g., PVP) for use with engineering polymers. In certain embodiments, the compositions disclosed herein may be used in thermosets, thermoplastics, coatings, adhesives, sizing agents, membranes, and film formation to provide materials having improved properties (e.g., increases in mechanical, thermal, electrical, and vibration properties). In one aspect, the present disclosure provides compositions comprising a plurality of graphene particles and a polymer. In another aspect, the compositions can be used in fiber sizing.

### BRIEF DESCRIPTION OF THE DRAWINGS

FIG. 1 shows, from left to right, 0, 0.1% and 1% of the composition as described herein.

FIG. 2 shows a composition flaked dried overnight at room.

FIG. 3 shows an SEM image of a control carbon fiber.

FIG. 4 shows an SEM image of a fiber treated with a graphene composition according to the present disclosure.

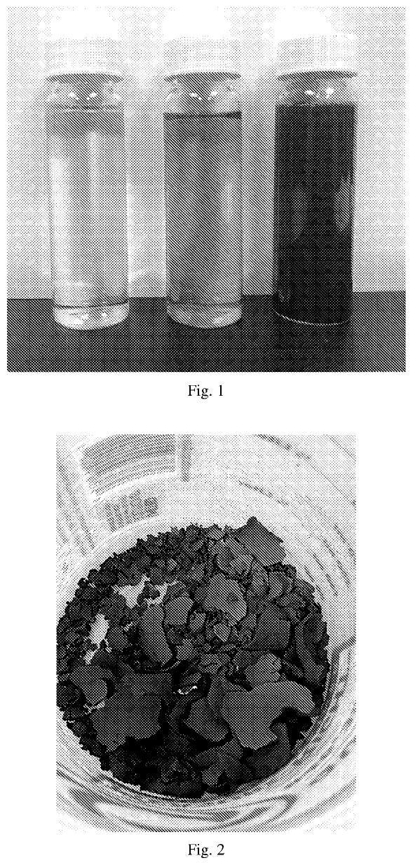

### DETAILED DESCRIPTION OF THE INVENTION

In certain embodiments, the disclosure relates to treating graphene with a polymer (e.g., PVP) to form a molecular bond that enables the graphene and/or graphene oxide to become a solid, pellet-like material, wherein the polymer acts as a binder and surfactant. This is to enable easy handling and dosing with said pellets, where the pellets rewet and can disperse into other polymers easily. The materials may also become either a solvent or water borne system. In some embodiments, the disclosure relates to a method of turning hard-to-handle nanomaterials that require special handling procedures into a form that is usable in liquid polymer systems as well as thermoplastic compounding. This solves the problem of additive integration that has challenged industries for decades.

In certain embodiments, the disclosure relates to a polymer (e.g., PVP) and graphene pellets, flakes, or films, which may then be dosed into thermoset or thermoplastic polymers in a scalable process. In certain embodiments, these pellets, flakes, or films, are formed by a reaction between graphene and the polymer (e.g., PVP). The PVP used in such a reaction can be K-15, K-30, K-90, or any derivative thereof. The graphene used in such a reaction can have many forms. Monolayer (1 layer), few layer (2-5 layers), and many layer (5-10 layers) graphenes are usable. One can also use graphenes that are either flat, wrinkled or crumpled or a combination thereof. While not wishing to be bound by any particular theory, the nature of the PVP particle may favor oxygen sites to form covalent bonds on the graphene particles, resulting in surfactant agents that bind together for handling purposes. In certain embodiments, the lateral particle size of the graphene can range anywhere between 50 nanometers to 50 micrometers. In certain embodiments, the bulk density of the graphene can range between 10 g/L up to 1,000 g/L, with a specific surface area ranging from 0.20 m²/g to 1,000 m²/g

In certain embodiments, the ID/IG ratio may range anywhere between 0.2 to 1.2, and the I2D/IG ratio must range anywhere between 0.4 to 1.2. In certain embodiments, materials needed are the PVP and powder graphene, as well as a polar or nonpolar solvent, such as isopropyl alcohol or water.

In certain embodiments, the processes disclosed herein are executable in very large reactors in short amounts of time while having up to a 99% recovery rate. In certain embodiments, the disclosure relates to traditional “masterbatch” pellets, which ease integration and may be compounded into specific polymers. In certain embodiments, the disclosure is polymer, graphene, and PVP agnostic; in other words, a wide range of graphene and PVP are usable in the compositions described herein. In certain embodiments, the graphene/PVP compositions described herein are mixed with water or solvent, which enables making graphene sizing agents and direct polymer dispersions for use in a multitude of ways.

In one aspect, the present disclosure provides compositions comprising a plurality of graphene particles and a polymer.

In certain embodiments, the graphene particles comprise a single layer of graphene. In certain embodiments, the graphene is few layer graphene. In other embodiments, the graphene particles comprise a plurality of layers of graphene. In certain embodiments, the graphene particles comprises 1 2, 3, 4, 5, 6, 7, 8, 9, or 10 layers of graphene. Examples of natural and synthetic graphene suppliers include Levidian Nanosystems (Cambridge, UK), NanoXplore (Ontario, Canada), Hydrograph (Toronto, Canada), First Graphene (Henderson, Australia), Universal Matter (Burlington, ON Canada), Versarien (Gloucestershire, UK), and 2DM (Singapore).

In certain embodiments, the graphene particles are flat. In certain embodiments, the graphene particles are wrinkled. In certain embodiments, the graphene particles are crumpled.

In certain embodiments, the graphene particles have a lateral particle size of 50 nanometers to 50 micrometers.

In certain embodiments, the plurality of graphene particles has a bulk density of 10 g/L to 1,000 g/L.

In certain embodiments, the plurality of graphene particles has a specific surface area from 0.20 m²/g to 1,000 m²/g. In certain embodiments, the specific surface area is from about 75 m²/g to about 1,000 m²/g or preferably about 75 m²/g to about 750 m²/g.

In certain embodiments, the composition has a Raman spectra wherein the ID:IG ratio is 0.2 to 1.2.

In certain embodiments, the composition has a Raman spectra wherein the 12D/IG ratio is 0.4 to 1.2.

In certain embodiments, the plurality of graphene particles comprises about 1 w/w %, about 2 w/w %, about 3 w/w %, about 4 w/w %, about 5 w/w %, about 6 w/w %, about 7 w/w %, about 8 w/w %, about 9 w/w %, or about 10 w/w % of the composition. In certain embodiments, the plurality of graphene particles comprises up to about 15 w/w %, of the composition. In certain embodiments, the plurality of graphene particles about 1 w/w % to about 15 w/w % of the composition. In certain embodiments, the plurality of graphene particles comprises about 6 w/w % of the composition.

In certain embodiments, the plurality of graphene particles comprises about 0.1 w/w %, about 2 w/w %, about 0.3 w/w %, about 4 w/w %, about 0.5 w/w %, about 6 w/w %, about 0.7 w/w %, about 0.8 w/w %, about 0.9 w/w %, or about 1 w/w % of the composition. In certain embodiments, the plurality of graphene particles comprises up to about 2 w/w %, of the composition. In certain embodiments, the plurality of graphene particles about 0.1 w/w % to about 1.5 w/w % of the composition. In certain embodiments, the plurality of graphene particles comprises about 0.6 w/w % of the composition.

In certain embodiments, the composition has a form of a film, a pellet, or a flake.

In certain preferred embodiments, the graphene is formed from cracked methane.

In certain embodiments, the polymer is a thermoplastic. In certain embodiments, the polymer is a water soluble.

In certain preferred embodiments, the polymer is a poly(vinylpyrrolidone) (PVP). In certain embodiments, the PVP has an average molecular weight of about 8,000 Daltons (e.g., PVP K-15). In other embodiments, the PVP has an average molecular weight of about 60,000 Daltons (e.g., PVP K-30). In yet other embodiments, the PVP has an average molecular weight of about 1,570,000 Daltons (e.g., PVP K-90).

In some embodiments, the graphene is present at about 35% to about 75% per total weight, such as about 50% to about 60%, per total weight of the graphene/polymer composition. For example, a solid composition that comprises about 35% graphene may comprise about 65% polymer (e.g., PVP). In certain preferred embodiments, the amount of graphene present in the solid composition is about equal to or is greater than the amount of polymer, for example the composition may be 50/50 graphene/PVP, about 55% graphene and about 45% PVP, about 60% graphene and about 40% PVP, about 70% graphene and about 30% PVP or about 80% graphene and about 20% PVP.

In certain embodiments, the graphene/polymer solid composition is a flake. In some embodiments, the flake has a particular thickness, for example the flake can be from about 5 μm thick to about 200 μm thick or about 50 μm thick to about 150 μm thick. For example, the flake can be about 75 μm thick.

A method of making the graphene/polymer composition may include a step of dispersing graphene in a solvent (e.g., isopropanol) thereby to produce a slurry; a step of incubating the slurry thereby forming an incubated slurry, for example for up to 21 (e.g., 14) days; a step contacting the incubated slurry with a polymer (e.g., PVP), optionally in the presence of agitation, thereby forming a graphene/polymer compound; a step of casting the graphene/polymer compound thereby forming a cast compound; and a step of drying the cast compound thereby forming the graphene/polymer solid composition. In certain embodiments, the method includes at least 3 or at least 4 of these steps. In certain embodiments, the method consists of at least 3, at least 4, or all of these steps.

In certain embodiments, the composition further comprises a polar solvent. Illustratively, the solvent may be used to emulsify the solid composition of graphene/polymer. In certain preferred embodiments, the polar solvent comprises water or isopropanol. In certain further preferred embodiments, the polar solvent is a mixture of water and isopropanol.

In certain embodiments, the composition further comprises a non-polar solvent.

In certain embodiments, the composition is stable under ambient conditions (e.g., 22° C. and 1 atmosphere of pressure) for at least 10 days as compared to graphene. In certain embodiments, the composition remains in solution under ambient conditions (e.g., 22° C. and 1 atmosphere of pressure) for at least 10 days as compared to graphene.

In certain embodiments, the graphene/polymer composition comprises about 0.1 w/w %, about 0.2 w/w %, about 0.5 w/w %, about 1 w/w %, about 2 w/w %, about 3 w/w %, about 4 w/w %, about 5 w/w %, about 6 w/w %, about 7 w/w %, about 8 w/w %, about 9 w/w %, or about 10 w/w % of the solvent-containing composition. In certain embodiments, the graphene/polymer composition comprises up to about 1 w/w %, up to about 5 w/w %, or up to about 15 w/w % of the solvent-containing composition. In certain embodiments, the plurality of graphene/polymer composition is about 0.1 w/w % to about 15 w/w % of the solvent-containing composition.

In another aspect, the present disclosure provides a copolymer comprising a composition disclosed herein.

In another aspect, the present disclosure provides a membrane comprising a composition disclosed herein.

In another aspect, the present disclosure provides a sizing agent comprising a composition disclosed herein. In certain embodiments, the sizing agent is used in a method to size a fiber (e.g., a virgin fiber or a recycled fiber). In some embodiments, the sizing composition comprises water.

In some embodiments, the composition is present at about 0.01% to about 5% w/w in the sizing composition. In some embodiments, the composition is present at about 0.01% to about 4% w/w or about 0.01% to about 1% w/w of the sizing composition.

In some embodiments, the sizing agent is applied to a fiber to form a graphene-fiber material. For example, in certain preferred embodiments the sizing agent is applied to a carbon fiber. In certain preferred embodiments the sizing agent is applied to a recycled carbon fiber.

In some embodiments the graphene-fiber material is compounded into a polymeric material to form a compounded polymeric material to form a compounded composition. Illustrative polymeric materials include thermoplastics that are known in the art. In some embodiments, the polymeric material is a nylon, for example a nylon 6 homopolymer. In certain preferred embodiments, the polymeric material is a recycled nylon 6 homopolymer.

In some embodiments, the graphene-fiber material is present in the compounded composition at a particular percent by weight. For example, the graphene-fiber material may be present at about 5% to about 50% by weight of the composition or about 5% to about 35% by weight of the composition.

In preferred embodiments, the compounded polymeric material having the graphene-fiber material present demonstrates advantageous improvements in at least one of, but preferably more than one of, flex, tensile, IZOD notched impact, and IZOD unnotched impact properties according to ASTM standards D790, D638, D256, and D4812, respectively, as compared to a compounded polymeric material that does not have the graphene present. For example, in certain preferred embodiments, the tensile strength may improve by at least 5%, the tensile modulus may improve by at least 3%, the elongation at yield may improve by at least 40%, the elongation at break may improve by at least 40%, or combinations thereof, relative to a polymeric material that lacks the graphene-fiber material. For example, in certain preferred embodiments, the flex strength may improve by at least 10% or at least 15%, the flex mod may improve by at least 3%, or a combination thereof relative to a polymeric material that lacks the graphene-fiber material. For example, in certain preferred embodiments, the izod impact strength (notched) may improve by at least 10% or at least 15%, the izod impact strength (unnotched) may improve by at least 25% or at least 30%, or a combination thereof, relative to a polymeric material that lacks the graphene-fiber material.

### Definitions

Unless otherwise defined herein, scientific and technical terms used in this application shall have the meanings that are commonly understood by those of ordinary skill in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

As used herein, the phrase “ID:IG” ratio refers to the ratio of the intensity between the D and the G bands in the Raman spectra of a given substance (e.g., a polymer composition).

### EXAMPLES

The invention now being generally described, it will be more readily understood by reference to the following examples which are included merely for purposes of illustration of certain aspects and embodiments of the present invention and are not intended to limit the invention.

### Example 1: Synthesis of Exemplary Compositions of the Disclosure

A slurry of solvent and graphene can be made, loading it anywhere between 0.5-50% wt of the solvent used. In one instance, 6% wt graphene was used in relation to IPA. The mixture was then agitated for 5-10 minutes to ensure saturation. The mixture was then measured out with enough solvent slurry to then dose with PVP. The mixture was agitated for approximately two hours at room temperature. At approximately two-hour mark, the mixture was poured into a wide container to spread mixture thin, ranging anywhere between 1-1000 micrometers thick.

In one embodiment, the mixture was poured roughly 10 micrometers deep. The mixture can then be dried (e.g., from between room temperature up to 200° C. for anywhere between two minutes and 24 hours).

In one embodiment, the mixture was dried at room temperature for 24 hours.

At the end of the drying time, the pellets, films or flakes can then be used (e.g., in other solvent or polymer systems to rewet and interact to form highly stable suspensions that allow for high performance values).

### Example 2: Preparation of Exemplary Composition

100 g of few layer graphene was dispersed in 1659.3 g IPA in a bag to produce a thick slurry, which was distributed into two 32 oz. glass jars for storage. When swirled, the graphene stuck to the sides of the glass and did not run down; this graphene could be recovered by re-wetting.

14 days later, 113.1 g of the slurry was separated and agitated, then dosed with 5.3 g K90 PVP. The resulting mixture was agitated at 100 rpm for 2 h at about 23° C., then cast into a mold.

Evaporation for 100 minutes yielded 11.6 g of flakes, which were roughly 100 μm thick. The product emulsified in water and in IPA (1 wt % in IPA).

### Example 3: Sizing and Compounding

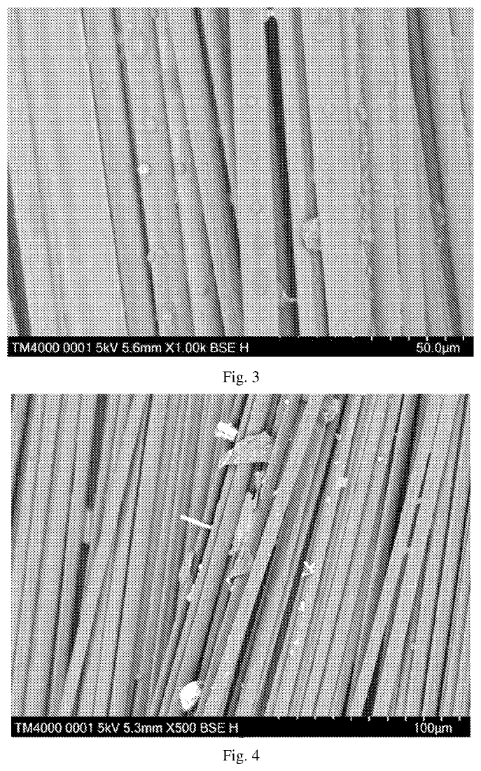

A sizing procedure using a recycled carbon fiber (Fenix Fiber by Vartega) was performed according to US20230139377A1, the entirety of which is incorporated herein by reference. A slurry of about 470 grams of water comprising 16.7% wt solids was used in the procedure. The solution was incorporated into a water sizing solution for use in the sizing process of the Fenix Fiber. The resulting fiber achieved a high utilization rate of the graphene slurry as well as successful incorporation of the material. See FIG. 3 for an SEM image of control sample, and FIG. 4 for an SEM image sample sized with graphene solution.

The graphene-recycled carbon fiber was then compounded into a nylon 6 homopolymer (Advansix Aegis H8202NLB) at a 20% wt loading of the total composite weight. The material was compounded on a 27 mm Leistritz with a 40:1 L/D at a feed rate of 70 lbs/hr and a screw RPM of 200. The barrel was heated between 240-260° C. across all barrels.

The control sample was prepared by compounding a recycled carbon fiber that had not been treated with the graphene-PVP solution into a nylon 6 homopolymer (Advansix Aegis H8202NLB) at a 20% wt loading of the total composite weight. The material was compounded on a 27 mm Leistritz with a 40:1 L/D at a feed rate of 70 lbs/hr and a screw RPM of 200. The barrel was heated between 240-260° C. across all barrels.

The resulting samples were then tested for flex, tensile, IZOD notched impact, and IZOD unnotched impact properties according to ASTM standards D790, D638, D256, and D4812, respectively. Testing results are shown in Tables 1-3.

TABLE 1

| | Tensile | Tensile | Tensile | Tensile | Elong. | Elong. | Elong. | Elong. |
|---|---|---|---|---|---|---|---|---|
| | Strength | Strength | Modulus | Modulus | at Yield | at Yield | at Break | at Break |
| Sample | (psi) | Std. Dev. | (psi) | Std. Dev. | (%) | Std. Dev. | (%) | Std. Dev. |
| Control | 23200 | 277 | 2000000 | 133000 | 1.86 | 0.08 | 1.86 | 0.08 |
| 1 | 25200 | 299 | 2070000 | 63000 | 2.79 | 0.06 | 2.79 | 0.06 |

TABLE 2

| | Flexural | Flexural | Flexural | Flexural |
|---|---|---|---|---|
| | Strength | Strength | Modulus | Modulus |
| Sample | (psi) | Std. Dev. | (psi) | Std. Dev. |
| Control | 30200 | 1054 | 1290000 | 17800 |
| 1 | 35700 | 267 | 1360000 | 21200 |

TABLE 3

| | Izod Impact | Izod Impact | Izod Impact | Izod Impact |
|---|---|---|---|---|
| | Notched | Notched | UnNotched | UnNotched |
| Sample | (ft-lb/in) | Std. Dev | (ft-lb/in) | Std. Dev. |
| Control | 1.217 | 0.035 | 11.084 | 0.377 |
| 1 | 1.406 | 0.036 | 15.178 | 0.458 |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations

What is claimed:

1. A composition comprising a plurality of graphene particles and a polymer.

2. The composition of claim 1, wherein the graphene particles comprise a single layer of graphene.

3. The composition of claim 1, wherein the graphene particles comprise a plurality of layers of graphene.

4. The composition of claim 3, wherein the graphene particles comprise 1, 2, 3, 4, 5, 6, 7, 8, 9, or 10 layers of graphene.

5. The composition of any one of claims 1-4, wherein the graphene particles are flat.

6. The composition of any one of claims 1-5, wherein the graphene particles are wrinkled.

7. The composition of any one of claims 1-6, wherein the graphene particles are crumpled.

8. The composition of any one of claims 1-7, wherein the graphene particles have a lateral particle size of 50 nanometers to 50 micrometers.

9. The composition of any one of claims 1-8, wherein the plurality of graphene particles has a bulk density of 10 g/L to 1,000 g/L.

10. The composition of any one of claims 1-9, wherein the plurality of graphene particles has a specific surface area from about 0.20 m²/g to about 1,000 m²/g, e.g., from about 75 m²/g to about 1,000 m²/g, or preferably about 75 m²/g to about 750 m²/g.

11. The composition of any one of claims 1-10, wherein the composition has a Raman spectrum wherein the ID:IG ratio is 0.2 to 1.2.

12. The composition of any one of claims 1-10, wherein the composition has a Raman spectrum wherein the I2D:IG ratio is 0.4 to 1.2.

13. The composition of any one of claims 1-12, wherein the polymer is a thermoplastic.

14. The composition of any one of claims 1-13, wherein the polymer is a water-soluble.

15. The composition of any one of claim 1-12 or 14, wherein the polymer is a poly (vinylpyrrolidone) (PVP).

16. The composition of claim 15, wherein the PVP has a number average molecular weight of about 8,000 Daltons (e.g., PVP K-15).

17. The composition of claim 15, wherein the PVP has a number average molecular weight of about 60,000 Daltons (e.g., PVP K-30).

18. The composition of claim 15, wherein the PVP has a number average molecular weight of about 1,570,000 Daltons (e.g., PVP K-90).

19. The composition of any one of claims 1-18, wherein the plurality of graphene particles comprises about 1 w/w %, about 2 w/w %, about 3 w/w %, about 4 w/w %, about 5 w/w %, about 6 w/w %, about 7 w/w %, about 8 w/w %, about 9 w/w %, or about 10 w/w % of the composition.

20. The composition of any one of claims 1-18, wherein the plurality of graphene particles comprises up to about 15 w/w % of the composition, e.g., about 6 w/w % of the composition.

21. The composition of any one of claims 1-20, wherein the composition further comprises a polar solvent.

22. The composition of claim 21, wherein the polar solvent comprises water or isopropanol.

23. The composition of claim 21, wherein the polar solvent is a mixture of water and isopropanol.

24. The composition of any one of claims 1-23, wherein the composition further comprises a non-polar solvent.

25. The composition of any one of claims 1-24, wherein the composition remains in solution under ambient conditions (e.g., 22° C. and 1 atmosphere of pressure) for at least 10 days as compared to graphene.

26. The composition of any one of claims 1-20, wherein the composition consists essentially of the plurality of graphene particles and the polymer.

27. The composition of any one of claims 1-26, wherein the composition has a form of a film, a pellet, or a flake.

28. The composition of any one of claims 1-27, wherein the composition is stable under ambient conditions (e.g., 22° C. and 1 atmosphere of pressure) for at least 10 days as compared to graphene.

29. A composite material comprising a composition of any one of claims 1-28 and a second polymer.

30. A copolymer comprising the composition of any one of claims 1-28.

31. A membrane comprising the composition of any one of claims 1-28.

32. A sizing agent comprising the composition of any one of claims 1-28.

33. The sizing agent of claim 32, wherein the sizing agent further comprises water.

34. The sizing agent of claim 32 or 33, wherein the composition is present at about 0.01% to about 5% w/w or about 0.01% to about 4% w/w or about 0.01% to about 1% w/w.

35. A method of sizing a fiber, wherein the method comprises applying the sizing composition according to any one of claims 32-34 to a fiber.

36. The method of claim 35, wherein the fiber is a carbon fiber.

37. The method of claim 35 or 36, wherein the fiber is a recycled fiber.

38. A fiber made according to the method of any one of claims 35-37.

39. A compounded composition, the compounded composition comprising a fiber according to claim 38 and a polymeric material.

40. The composition of claim 39, wherein the polymeric material comprises a nylon.

41. The composition of claim 40, wherein the nylon is a nylon 6 homopolymer.

42. The composition of any one of claims 39-41, wherein the fiber is present at about 5% to about 50% by weight of the composition.

43. The composition of any one of claims 39-42, wherein the fiber is a carbon fiber such as a recycled carbon fiber.

44. The composition of any one of claims 39-43, wherein at least one of the flex, tensile, IZOD notched impact, and IZOD unnotched impact properties are improved relative to a sample that does not include the composition.
